(19) United States
(12) Patent Application Publication
(10) Pub. No.: US 2013/0111439 A1
(43) Pub. Date: May 2, 2013

(54) SOFTWARE DEVELOPMENT PLATFORM WITH ENHANCED FEATURE CONTROL AND REUSABILITY

(71) Applicants: Andre Wagner, Sinsheim (DE); Markus Biehler, Landau (DE); Dirk Henrich, Sandhausen (DE); Erwin Pinter, Speyer (DE)

(72) Inventors: Andre Wagner, Sinsheim (DE); Markus Biehler, Landau (DE); Dirk Henrich, Sandhausen (DE); Erwin Pinter, Speyer (DE)

(21) Appl. No.: 13/283,585

(22) Filed: Oct. 28, 2011

(51) Int. Cl. G06F 9/44

(52) U.S. Cl. 717/121

(57) ABSTRACT

Various embodiments of systems and methods for solution development platform with enhanced feature control and reusability are described herein. In one aspect, the method executed by one or more computers in a network of computers includes receiving at least one of a business feature configuration group and one or more standard business features, associating at least one of the business feature configuration group and the one or more standard business features with a business object, and executing the business object based upon the at least one of the associated business feature configuration group and the associated one or more standard business features.

### BACKGROUND

Software development platforms typically provide a list of standard Business Objects (BOs) that can be used in a software solution. Typically, each standard BO has one or more standard features associated with it. For example, a development platform may provide standard features like a standard printing and a standard user interface (UI) associated with a standard BO (e.g., purchase order). Usually, if a standard BO is selected, all the standard features associated with the standard BO are automatically deployed or implemented in the software solution. For example, if the solution developer selects ‘purchase order’ for their application then all the standard features associated with the purchase order, e.g., the standard printing, the standard UI, etc., are automatically activated/implemented in the software solution.

However, it may not always be desirable to activate all the standard features of a BO. For example, a user may desire to print the purchase order with some additional information and therefore, may not desire standard printing of the purchase orders. Further, if a design requires few solution specific features then a solution developer might need to develop a new business object with all required features, i.e., some standard features and some solution specific features (e.g., printing). Additionally, one or more instances of the standard BO, created in a solution-specific UI, may start appearing in the standard UI which may cause inconsistency. For example, if the solution developer cancels a purchase order instance (PO1) in the standard UI and forgets to cancel the purchase order instance (PO1) in the solution-specific UI, this too results inconsistency. Therefore, it might be an extra burden on a user (e.g., the solution developer) to check and maintain the consistency.

### SUMMARY OF THE INVENTION

Various embodiments of systems and methods for solution development platform with enhanced feature control and reusability are described herein. In one aspect, the method executed by one or more computers in a network of computers includes receiving at least one of a business feature configuration group and one or more standard business features. The business feature configuration group and/or the one or more standard business features are associated with a business object. The business object is executed based upon at least one of the associated business feature configuration group and the associated one or more standard business features.

These and other benefits and features of embodiments of the invention will be apparent upon consideration of the following detailed description of preferred embodiments thereof, presented in connection with the following drawings.

### BRIEF DESCRIPTION OF THE DRAWINGS

The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system including a solution development platform with core services and business features to develop a software solution, according to an embodiment of the invention.

FIG. 2 is a block diagram of standard business features and a business feature configuration group (BFCG) associated with the business features, according to an embodiment of the invention.

FIG. 3 is a block diagram of the business feature configuration group, according to an embodiment of the invention.

FIG. 4 is a block diagram of a business object, according to an embodiment of the invention.

FIG. 5 is a block diagram of an outbound process agent for executing the business object, according to an embodiment of the invention.

FIG. 6 is a flow chart illustrating the steps performed to associate the business features configuration group (BFCG) and the standard business features with the business object, according to various embodiments of the invention.

FIG. 7 is a flow chart illustrating the steps performed to group several configurable business features together inside the business feature configuration group, according to an embodiment of the invention.

FIG. 8 is a flow chart illustrating the steps performed to execute the business objects, according to an embodiment of the invention.

FIG. 9 is a block diagram of an exemplary computer system, according to an embodiment of the invention.

### DETAILED DESCRIPTION

Embodiments of techniques for solution development platform with enhanced feature control and reusability are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

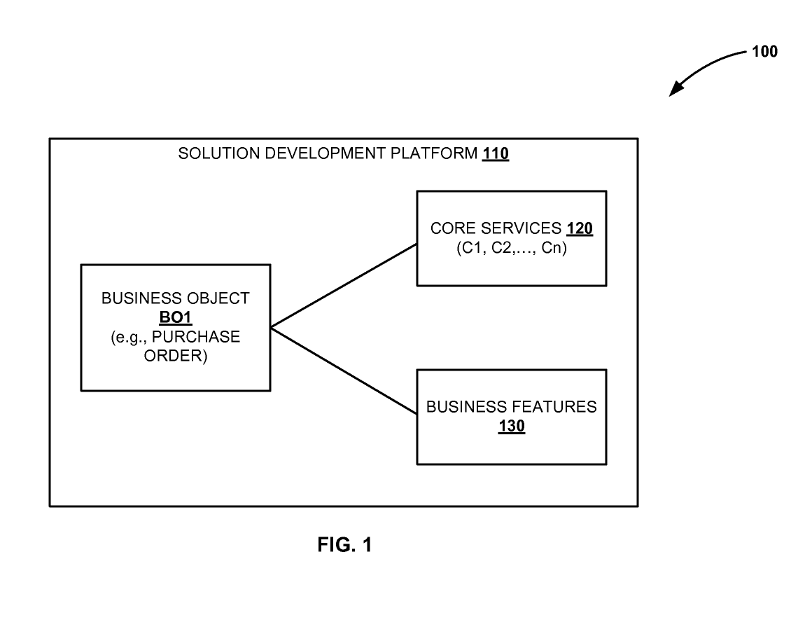

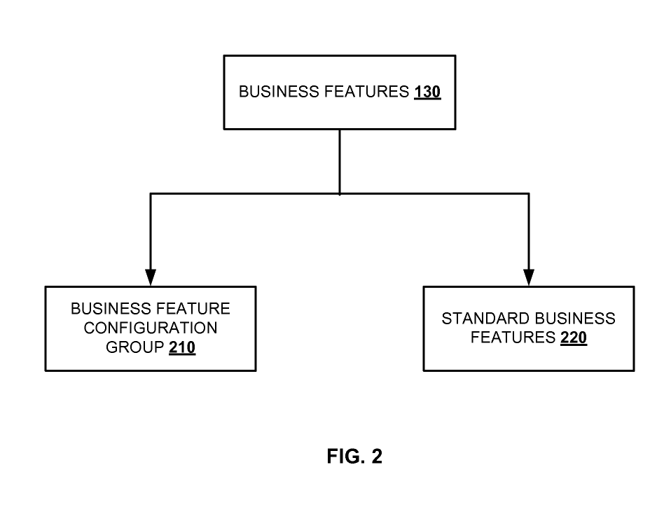

FIG. 1 illustrates one embodiment of a system 100 including a solution development platform (SDP) 110 to develop a software solution (not shown). The SDP 110 renders one or more business objects, e.g., a business object BO1 for user interaction. The business object BO1 may be associated with one or more core services 120 (C1-Cn) and business features 130. The core services 120 (C1-Cn) are predefined features that are automatically associated with the business object BO1. The business features 130 are explicitly associated with the business object BO1. For example, a user (e.g., solution developer) may explicitly associate the business features 130 with the business object BO1. The business features 130 may include configurable features (e.g., a business feature configuration group 210) or non-configurable features (e.g., standard features 220), as illustrated in FIG. 2. Typically, the business feature configuration group 210 and/or the standard features 220 are associated with the business object BO1. The business object BO1 is executed based upon the associated core services 120 and at least one of the associated business feature configuration group 210 and the standard features 220.

The business object BO1, e.g., a ‘purchase order’ may be an entity that is to be used in the software solution. The business object BO1 may be provided by the software development platform 110 or may be defined by the user. The business object BO1 may be associated with the one or more core services 120 (C1-Cn). The core services 120 (C1-Cn) are predefined services. The core services 120 (C1-Cn) may be related to data storage, consistency check, and/or process integration, etc. In one embodiment, the core services 120 (C1-Cn) are automatically selected and associated with the business object BO1. In another embodiment, the user (e.g., the developer) may select the core services 120 (C1-Cn) to be associated with the business object BO1. In yet another embodiment, a selection/de-selection option for the core services 120 (C1-Cn) may be disabled. The selection option for the business features 130 however, is typically enabled.

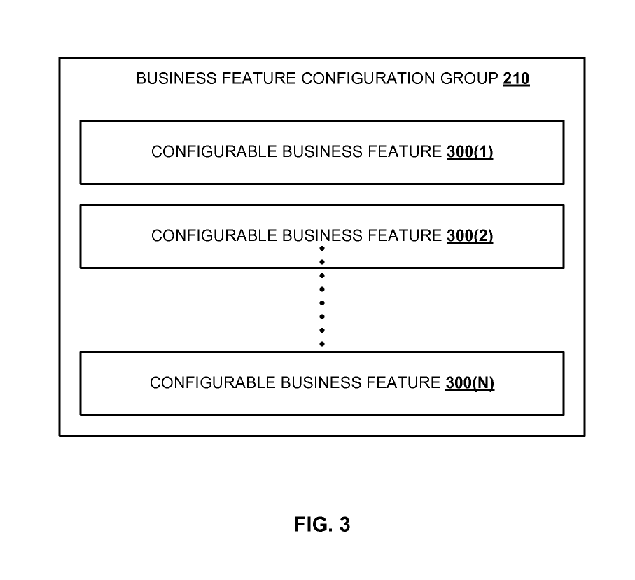

The business features 130 may be associated with the business feature configuration group (BFCG) 210. The BFCG 210 may be defined by the user. Typically, the user may define the BFCG 210 by specifying a code and a description or name for the BFCG 210. For example, the user may define the BFCG 210 (e.g., xyz order) with the code: ‘ . . . /XYZ/ABC’ and the description: xyz order. Once the BFCG 210 is defined, the user may integrate the BFCG 210 with one or more configurable business features 300 (1-n) (refer to FIG. 3).

The configurable business features 300 (1-n) are solution specific features that may be defined by the user (i.e., developer). In one embodiment, the configurable business features 300 (1-n) may start with a term “solution-specific.” Typically, the configurable business features 300 (1-n) are related to a peripheral or hardware feature that can be modified or defined by the user based upon the business requirement. For example, if the user requires specific type of output or printing then the user may select the configurable business feature 300(1) (e.g., solution-specific output for PO) that can be configured by the user.

Typically, the user selects the configurable business features 300 (1-n) to be a part of BFCG 210. The selected configurable business features 300 (1-n) is a part of the BFCG 210. Alternately, the one or more configurable business features 300 (1-n) may be grouped together inside the BFCG 210. For example, the user may integrate the configurable features 300(1) (e.g., ‘solution-specific output for PO’) and 300(2) (e.g., ‘solution specific access for PO’) together within the BFCG 210 (i.e., the xyz order).

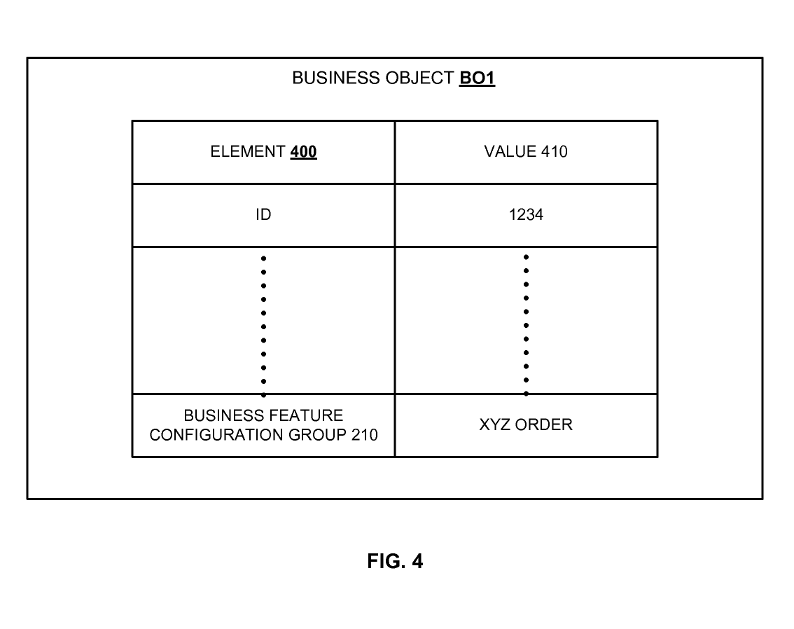

The BFCG 210 may be assigned to the business object BO1. For example, the BFCG 210 (i.e., the xyz order having code: /XYZ/ABC) may be assigned to the business object BO1 (i.e., purchase order). The one or more configurable business features 300 (1-n) that are part of the BFCG 210 are automatically assigned to the business object BO1. In one embodiment, as illustrated in FIG. 4, the business object BO1 (purchase order) may include elements 400 and values 410 (e.g., name or description) for each of the corresponding elements. For example, the business object BO1 (purchase order) may include an element namely an identifier (ID) and associated BFCG 210 and their corresponding values or name as ‘1234’ and ‘xyz order,’ respectively.

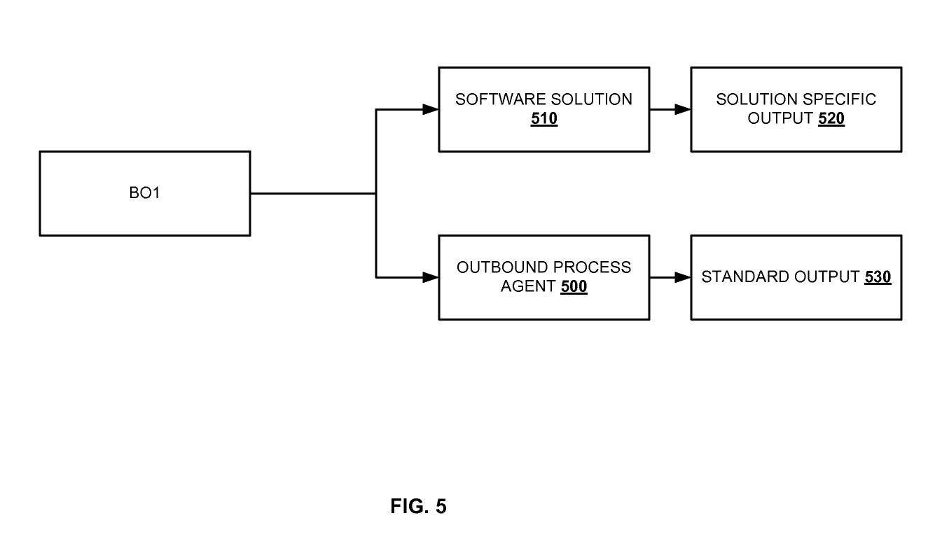

The business object BO1 may be executed based upon the associated BFCG 210. Typically, while executing the business object BO1 it is determined whether any BFCG 210 is assigned or associated with the business object BO1. In one embodiment, an outbound process agent or OPA 500 (refer to FIG. 5) may check if any BFCG 210 or any configurable business features 300 (1-n) is associated with the business object BO1. If the BFCG 210 is associated with the business object BO1 then the business object BO1 is executed based upon the associated BFCG 210 or the one or more configurable business features 300 (1-n) included inside the BFCG 210. For example, the business object BO1 may be executed based upon the configurable business features 300(1) (e.g., solution-specific output for PO) included within the BFCG 210. Typically, a software solution 510 (refer to FIG. 5) executes the business object BO1 to generate a solution-specific output 520. The solution-specific output 520 includes at least one of a solution-specific print out form, a solution-specific email, a solution-specific fax, a solution-specific work list, and a solution-specific user interface. In one embodiment, if it is determined that the BFCG 210 is associated with the business object BO1 then the accessibility of the business object BO1 may be restricted to the solution-specific UI.

If the business object BO1 is not associated with the BFCG 210 then the business object BO1 is executed based upon the standard features 220. Typically, if it is determined that the business object BO1 is not associated with the BFCG 210 then the OPA 500 executes the business object BO1 to generate the standard output 530. In one embodiment, the standard output 530 includes at least one of a standard print out form, a standard email, a standard fax, a standard work list, and a standard user interface. In another embodiment, if it is determined that the business object BO1 is not associated with the BFCG 210 then the accessibility of the business object BO1 may be restricted to the standard UI.

In one embodiment, one or more business object instances (not shown) of the business object BO1 may be created. The execution of the business object BO1 results in the execution of the one or more business object instances. In one embodiment, if a business object instance is created in the solution specific UI then the accessibility of the business object instance may be restricted in the standard UI. Alternately, if the business object instance is created in the standard UI then the accessibility of the business object instance may be restricted in the solution-specific UI.

In another embodiment, if the user does not define the BFCG 210 then standard features 220 are automatically selected/applied. For example, if the user does not select the configurable business feature 300(1) (e.g., solution-specific output for PO) then the corresponding standard feature, i.e., standard output for PO is automatically selected/enabled.

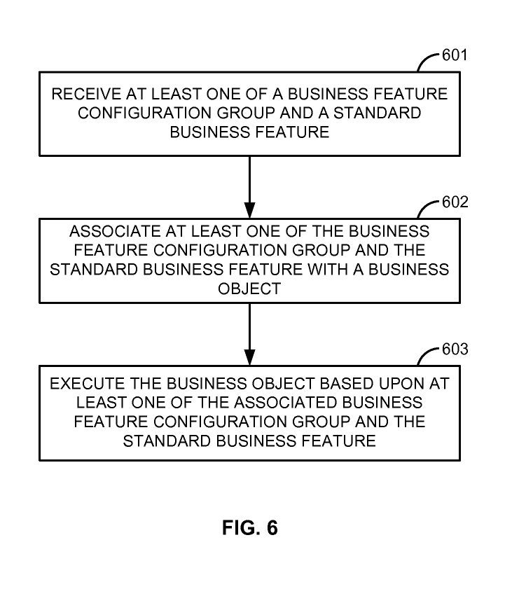

FIG. 6 is a flowchart illustrating a method for associating the business feature configuration group (BFCG) 210 and the standard business features 220 with the business object BO1. Typically, the BFCG 210 and/or the standard business features 220 are received or identified at step 601. The BFCG 210 and/or the standard business features 220 are associated with the business object BO1 at step 602. Finally, the business object BO1 is executed based upon at least one of the associated BFCG 210 and the standard business features 220 at step 603.

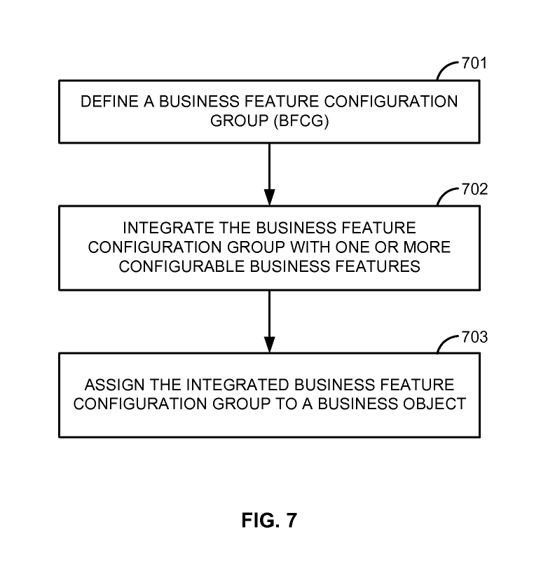

FIG. 7 is a flowchart illustrating a method for grouping several configurable business features 300 (1-n) together. Typically, the user defines the BFCG 210 at step 701. The user may define the BFCG 210 by specifying the code and the description or name for the BFCG 210. For example, the user may define the BFCG 210 (e.g., xyz order) with the code: ‘ . . . /XYZ/ABC’ and the description: xyz order. Once the BFCG 210 is defined, the user may integrate the BFCG 210 with one or more configurable business features 300 (1-n) at step 702. For example, the user may integrate the configurable business features 300(1) (i.e., ‘solution-specific output for PO’) and 300(2) (e.g., ‘solution specific access for PO’) together within the BFCG 210 (i.e., the xyz order). The integrated BFCG 210 may be assigned to the business object BO1 at step 703. The business object BO1 may be executed based upon the corresponding assigned BFCG 210.

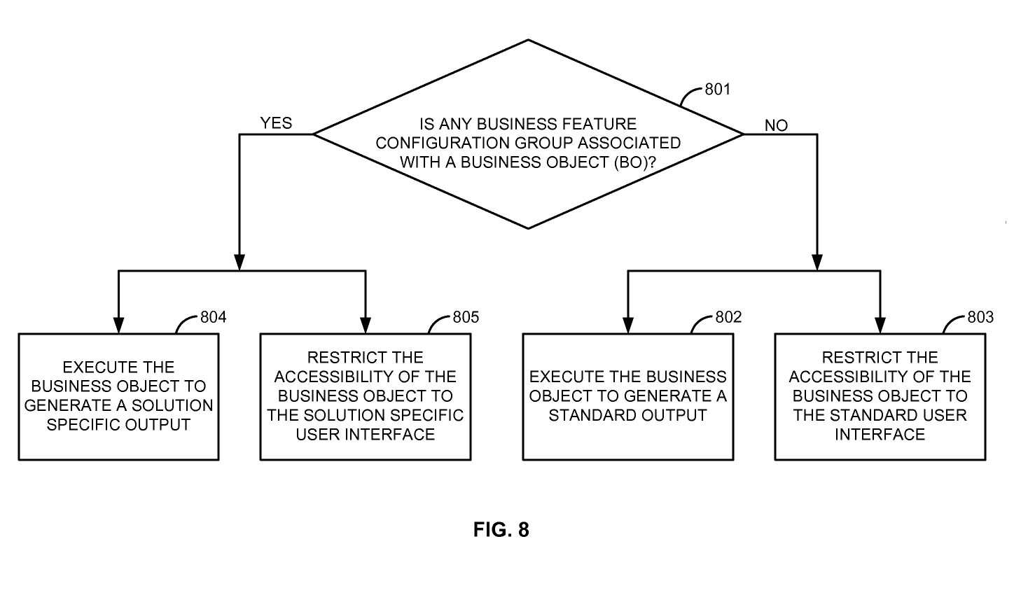

FIG. 8 is a flowchart illustrating a method for executing the business object BO1. Typically, while executing the business object BO1 it is determined if any BFCG 210 is assigned or associated with the business object BO1 at step 801. Typically, the outbound process agent 500 checks if any BFCG 210 or the configurable business features 300 (1-n) are associated with the business object BO1. If the BFCG 210 is not associated with the business object BO1 (step 801: NO) then the business object BO1 is executed based upon the standard features 220. Typically, the OPA 500 executes the business object BO1 to generate the standard output 530 at step 802. In one embodiment, the standard output 530 includes at least one of the standard print out form, the standard email, the standard fax, the standard work list, and the standard user interface. In another embodiment, if it is determined that the BFCG 210 is not associated with the business object BO1 (step 801: NO) then the accessibility of the business object BO1 is restricted to the standard UI at step 903. In case the business object BO1 is associated with the BFCG (step 801: YES) then the business object BO1 is executed based upon the associated BFCG 210 and the one or more configurable business features 300 (1-n) included inside the BFCG 210. Typically, the business object BO1 is executed by the software solution 510 to generate the solution-specific output 520 at step 804. The solution-specific output 520 includes at least one of the solution-specific print out form, the solution-specific email, the solution-specific fax, the solution-specific work list, and the solution-specific user interface. In another embodiment, if it is determined that the business object BO1 is associated with the SFCG 210 (step 801: YES) then the accessibility of the business object BO1 is restricted to the solution-specific UI at step 805.

The embodiments provide flexible solution development platform which enables the users (solution developers) to make selection from the plurality of configurable business features and the standard business features. Essentially, the solution developer can select or reuse the configurable features and/or the standard business features based upon their specific business requirement. The reuse of the selected standard business features obviates the redundant development of the business features from the scratch and saves resources, time, and effort. Further, the solution developer can define the configurable features, i.e., their solution specific business features. For example, the solution developer can define the solution specific printing (e.g., the solution specific output of PO) for their software solution. The solution developer can also select the standard features (e.g., standard printing) instead of solution specific feature(s). Importantly, the non selection of the solution-specific feature automatically enables the selection of the corresponding standard feature. Additionally, several configurable business features can be grouped together. Again, the group comprising several configurable business features (e.g., the BFCG) can be assigned to the one or more business objects and can be reused easily. Importantly, the BFCG can be stored at once and can be assigned to the one or more BOs which obviate the need to define all the business features separately inside each business objects. Moreover, the assignment of BFCG (including several configurable business features) to one or more BOs saves time, effort, and storage space. Finally, the embodiments also ensure automatic implementation of the core features to ensure data consistency, data storage, and process integration. At last, the consistency may also be ensured by restricting the access of the business object instances generated in the solution specific UI in the standard UI.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

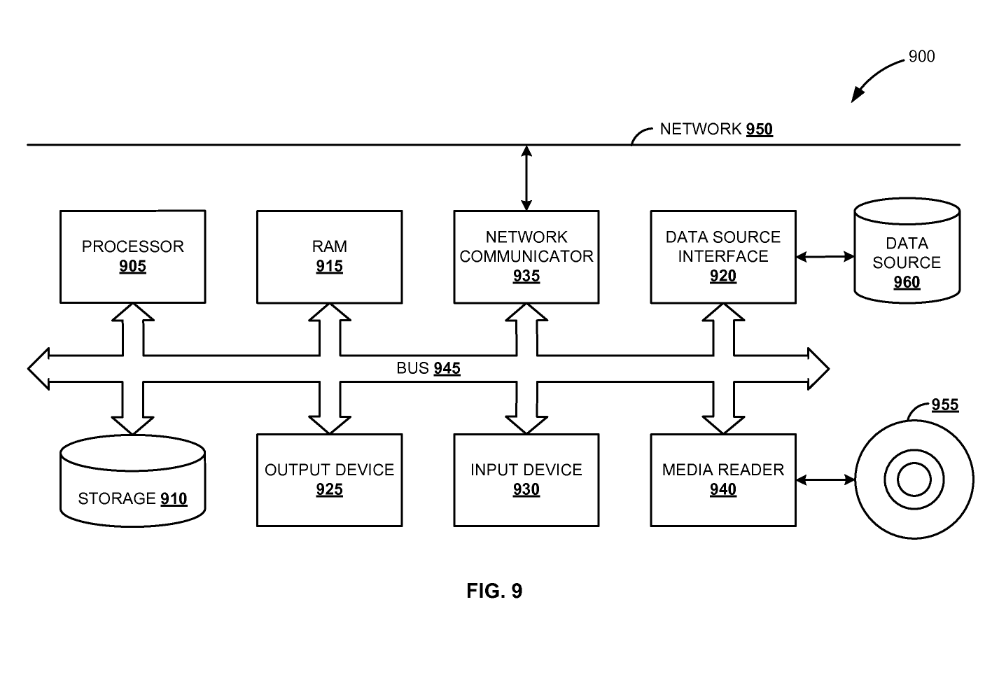

FIG. 9 is a block diagram of an exemplary computer system 900. The computer system 900 includes a processor 905 that executes software instructions or code stored on a computer readable storage medium 955 to perform the above-illustrated methods of the invention. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment of the invention, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by one or more computers in a network of computers causes the performance of the following operation:
the one or more computers receiving at least one of a business feature configuration group comprising configurable business features and one or more standard business features;
the one or more computers associating at least one of the business feature configuration group and the one or more standard business features with a business object; and
the one or more computers executing the business object based upon the at least one of the associated business feature configuration group and the associated one or more standard business features.

2. The article of manufacture of claim 1, wherein the business feature configuration group is defined by a user.

3. The article of manufacture of claim 2, wherein the configurable business features are solution-specific business features to be developed by the user.

4. The article of manufacture of claim 1 further comprising instructions which when executed cause the one or more computers to:
identify one or more core services related to at least one of a data storage, a consistency check, and a process integration; and
associate the one or more core services with the business object.

5. The article of manufacture of claim 1, wherein the business object is executed based upon the business feature configuration group to generate a solution-specific output.

6. The article of manufacture of claim 1 further comprising instructions which when executed cause the one or more computers to generate one or more business object instances associated with the business object, wherein executing the business object comprises executing the one or more business object instances associated with the business object.

7. The article of manufacture of claim 6, wherein if a business object instance is generated in a solution-specific user interface (UI) then the accessibility of the business object instance is restricted in a standard UI.

8. The article of manufacture of claim 1 further comprising instructions which when executed cause the one or more computers to perform at least one of the following:
define the business feature configuration group;
receive a user's selection of one or more configurable business features; and
integrate the one or more configurable business features with the business feature configuration group.

9. The article of manufacture of claim 8 wherein executing the business object based upon the at least one of the associated business feature configuration group and the associated one or more standard features comprises:
determining if the business feature configuration group is associated with the business object;
if the business feature configuration group is associated with the business object perform at least one of the following:
accessing the business object through a solution-specific user interface; and
generate a solution-specific output for the business object; and
if the business object is not associated with the BFCG perform at least one of the following:
accessing the business object through a standard user interface; and
generate a standard output for the business object.

10. A method for reusing and controlling business features implemented on a network of one or more computers, the method comprising:
the one or more computers receiving at least one of a business feature configuration group and one or more standard business features;
the one or more computers associating at least one of the business feature configuration group and the one or more standard business features with a business object; and
the one or more computers executing the business object based upon the at least one of the associated business feature configuration group and the associated one or more standard business features.

11. The method of claim 10 further comprising:
the one or more computers identifying one or more core services related to at least one of data storage, consistency check, and process integration; and
the one or more computers automatically associating the one or more identified core services with the business object.

12. The method of claim 10 further comprising:
the one or more computers generating one or more business object instances associated with the business object, wherein executing the business object comprises executing the one or more business object instances associated with the business object.

13. The method of claim 12 further comprising:
the one or more computers determining if a business object instance is generated in a solution-specific user interface (UI);
if the business object instance is generated in the solution-specific UI, restricting the access of the business object in a standard UI; and
if the business object instance is not generated in the solution-specific UI, restricting the access of the business object to the standard UI.

14. The method of claim 10 further comprising:
the one or more computers determining if the business feature configuration group is associated with the business object;
if the business feature configuration group is associated with the business object the one or more computers performing at least one of the following:
accessing the business object through a solution-specific user interface; and
generating a solution-specific output for the business object; and
if the business object is not associated with the BFCG the one or more computers performing at least one of the following:
accessing the business object through a standard user interface; and
generating a standard output for the business object.

15. A computer system for reusing and controlling features, comprising:
a memory to store program code; and
a processor communicatively coupled to the memory, the processor configured to execute the program code to cause one or more computers in a network of computers to:
receive at least one of a business feature configuration group and one or more standard business features;
associate at least one of the business feature configuration group and the one or more standard business features with a business object; and
execute the business object based upon the at least one of the associated business feature configuration group and the associated one or more standard business features.

16. The computer system of claim 15, wherein the processor is further configured to perform at least one of the following:
identify one or more core services related to at least one of a data storage, a consistency check, and a process integration; and
automatically associate the one or more core services with the business object.

17. The computer system of claim 15, wherein the processor is further configured to perform at least one of the following:
generate one or more business object instances associated with the business object;
determine if a business object instance is generated in a solution-specific user interface (UI);
if the business object instance is generated in the solution-specific UI, restrict the access of the business object instance in a standard UI; and
if the business object instance is not generated in the solution-specific UI, restrict the access of the business object instance to the standard UI.

18. The computer system of claim 15, wherein the processor is further configured to perform the following:
receive a user's selection of one or more configurable business features; and
integrate the one or more configurable business features with the business feature configuration group.

19. The computer system of claim 15, wherein the processor is further configured to perform at least one of the following:
determine if a business feature configuration group is associated with the business object; and
if the business feature configuration group is associated with the business object perform at least one of the following:
accessing the business object through a solution-specific user interface; and
generating a solution-specific output for the business object; and
if the business object is not associated with the BFCG perform at least one of the following:
accessing the business object through a standard user interface; and
generating a standard output for the business object.
